(19) United States
(12) Patent Application Publication
(10) Pub. No.: US 2014/0059291 A1
(43) Pub. Date: Feb. 27, 2014

(54) METHOD FOR PROTECTING STORAGE DEVICE DATA INTEGRITY IN AN EXTERNAL OPERATING ENVIRONMENT

(71) Applicants: Kashif Memon, Sunnyvale, CA (US); Pradeep Bisht, (US)

(72) Inventors: Kashif Memon, Sunnyvale, CA (US); Pradeep Bisht, (US)

(21) Appl. No.: 13/595,986

(22) Filed: Aug. 27, 2012

(51) Int. Cl. G06F 12/12; G06F 12/08

(52) U.S. Cl. 711/113; 711/159; 711/E12.019; 711/E12.07

(57) ABSTRACT

An invention is provided for protecting the data integrity of a cached storage device in an alternate operating system (OS) environment. The invention includes replacing an actual partition table for a disk with a dummy partition table. The dummy partition table is designed to render data on the disk inaccessible when the dummy partition table is used by an OS to access the data. During operation, the data on the disk can be accessed using information based on the actual partition table. In response to receiving a request to disable caching, the dummy partition table on the disk is replaced with the actual partition table, thus rendering the data on the formally cached disk accessible in an alternate OS environment where appropriate caching software is not present.

### BACKGROUND OF THE INVENTION

1. Field of the Invention

This invention relates generally to data integrity, and more particularly to protecting the data integrity of a storage device in an alternate operating system environment.

2. Description of the Related Art

Caching has long been used in storage environments to enhance the performance of slower storage devices, such as disk drives. In caching, a smaller and faster storage medium is utilized to temporarily store and retrieve frequently used data, while the larger and typically slower mass storage medium is used for long term storage of data. One caching methodology is write-back caching, wherein data written to a disk is first stored in a cache and later written to the mass storage device, typically when the amount of data in cache reaches some threshold value or when time permits.

FIG. 1 is a block diagram showing an exemplary prior art computer system 100 having write back caching capability. The exemplary prior art computer system 100 includes a central processing unit (CPU) 102 in communication with system memory 104, a cache 106, and a target storage device 108. In addition, loaded into system memory 104 is caching software 110, which functions to facilitate write-back caching functionality on the computer system 100.

As mentioned previously, the cache 106 generally comprises a smaller, faster access storage than that used for the target storage device 108. Because of the enhance speed of the cache 106, reads and writes directed to the cache 106 are processed much faster than is possible using the target storage device 108. Write-back caching takes advantage of these differences by sending all write requests to the write-back cache 106 before later transferring the data to the target storage device 108.

For example, when the CPU 102 processes a write request to write data to the target storage device 108, the caching software 110 intercepts the write request and writes the data to the cache 106 instead. This data often is referred to as “dirty” data because it has not yet been written to the target storage device 108, and later becomes “clean” data when the data is later written to the target storage device 108. The caching software 110 provides a complete view of the target storage device 108 to the user. That is, when the CPU 102 processes a read request for the same data, the caching software 110 again intercepts the read request and determines whether the data is stored in cache memory. When the data is stored in cache memory, the CPU 102 reads the data from the cache 106, otherwise the CPU 102 reads the data from the target storage device 108.

As can be appreciated, at any point in time data can be stored in the cache 106 and not yet updated on the target storage device 108, and therefore the target storage device 108 may not have a complete and consistent copy of what then user believes is stored there. As a result, if the user decides to move the target storage device 108 to another operating system (OS) environment where caching software 110 is not present the data on the target storage device 108 may get corrupted and become useless.

For example, when a file is partially stored on the target storage device 108 and partially stored in the cache 106, the caching software 110 provides a complete view of the file and the user sees the file as being completely stored on the target device 108. However, if the user moves the target storage device 108 to another OS environment where caching software 110 is not present, the file on the target storage device 108 will not be complete. However, the user does not know whether the file is complete or not and may attempt to modify the file. When the target storage device 108 is later brought back to the original OS environment, data integrity problems occur.

Traditionally, this data integrity problem was addressed by having the user disable the caching software 110 prior to removing the target storage device 108 to another OS environment. When the caching software 110 is disabled, it flushes all the dirty data from the cache 106 ensuring the data on target storage device 108 is complete and clean. Now, when the target storage device 108 is taken to another OS environment, no data corruption will occur as a result of caching.

Unfortunately, users do not always remember to disable the caching software 110 prior to removing the target storage device 108 and moving it to another OS environment. As a result, a forgetful user can still corrupt the data on the target storage device 108 despite the cache flushing capabilities of the caching software 110 because they forget to disable the caching software 110 prior to moving the target storage device 108.

In view of the foregoing, there is a need for systems and methods for protecting the data integrity of storage devices in alternate OS environments. Ideally, the systems and methods should provide some protection even when the user forgets to disable the caching software prior to moving a cached storage device to an alternate OS environment.

### SUMMARY OF THE INVENTION

Broadly speaking, embodiments of the present invention address these needs by providing a process for protecting the data integrity of a cached storage device in an alternate OS environment. In one embodiment, a method for protecting data integrity of a disk in an alternate operating system (OS) environment is disclosed. The method includes replacing an actual partition table for the disk with a dummy partition table. The dummy partition table is designed such that it renders data on the disk inaccessible when the dummy partition table is used by an OS to access the data. Thereafter, the data on the disk can be accessed using information based on the actual partition table. One manner in which to replace the partition table is to replace the actual master boot record for the disk with a replacement master boot record, wherein the replacement master boot record includes the dummy partition table. Typically, the replacement master boot record is stored in a boot sector of the disk, thus it will be loaded as if it were the master boot record for the disk when the disk is accessed in an alternate OS environment not having appropriate caching software.

A further method for protecting data integrity of a disk in an alternate OS environment is disclosed in a additional embodiment of the present invention. Similar to above, the method includes replacing the actual partition table for a disk with a dummy partition table that renders data on the disk inaccessible when used by an OS to access the data. Thereafter, the data on the disk can be accessed using information based on the actual partition table. In response to receiving a request to disable caching, the dummy partition table on the disk is replaced with the actual partition table. As above, this can be accomplished by replacing the actual master boot record for the disk with a replacement master boot record that includes the dummy partition table, and then replacing the replacement master boot record with the actual master boot record for the disk in response to receiving the request to disable caching. Generally, the actual partition table can be stored on a caching disk, in a non-boot sector of the cached disk, or any other place accessible to the caching software.

A computer program embodied on a computer readable medium for protecting the data integrity of a disk in an alternate OS environment is disclosed in yet a further embodiment of the present invention. The computer program includes computer instructions that replace an actual partition table for a disk with a dummy partition table that renders data on the disk inaccessible when the dummy partition table is used by an OS to access the data. Computer program instructions also are included that access the data on the disk using information based on the actual partition table. In one embodiment, computer instructions can be included that replace the actual master boot record for the disk with a replacement master boot record that includes the dummy partition table. As above, the replacement master boot record generally is stored in the boot sector of the disk. Computer instructions can further be included that replace the dummy partition table on the disk with the actual partition table in response to receiving a request to disable caching. In one embodiment, computer instructions are included that replace the replacement master boot record on the disk with the actual master boot record for the disk in response to receiving the request to disable caching.

In this manner, the dummy partition table renders the contents of the cached disk inaccessible when the cached disk is moved to an alternate OS environment where the appropriate caching software is not present. As a result, the user is reminded to return the cached disk back to the original computer system and disable the caching software in order to make the cached disk accessible in the alternate OS environment. Other aspects and advantages of the invention will become apparent from the following detailed description, taken in conjunction with the accompanying drawings, illustrating by way of example the principles of the invention.

### BRIEF DESCRIPTION OF THE DRAWINGS

The invention, together with further advantages thereof, may best be understood by reference to the following description taken in conjunction with the accompanying drawings in which:

FIG. 1 is a block diagram showing an exemplary prior art computer system having write back caching capability;

FIG. 2 is a block diagram showing an exemplary computer system with a cached disk having data integrity protection when moved to an alternate OS environment, in accordance with an embodiment of the present invention;

FIG. 3 is a diagram showing the exemplary cached disk, having a replacement master boot record for protecting the cached disk in alternate OS environments, in accordance with an embodiment of the present invention;

FIG. 4 is a block diagram showing an exemplary computer system wherein the cached disk has been fully updated and made complete in itself and can be safely accessed from an alternate OS where the caching software is not present, in accordance with an embodiment of the present invention;

FIG. 5 is a flowchart showing a method for protecting data integrity when a cached disk is moved to an alternate OS environment, in accordance with an embodiment of the present invention; and

FIG. 6 is flowchart showing a method for rendering the data stored on the cached disk accessible in alternate OS environments in response to receiving a request to disable caching, in accordance with an embodiment of the present invention.

### DETAILED DESCRIPTION OF THE PREFERRED EMBODIMENTS

An invention is disclosed for protecting the data integrity of a cached storage device in an alternate OS environment. In general, embodiments of the present invention utilize the partition table of a disk to provide a mechanism for protecting data integrity of a cached disk. Because an OS attempts to access the disk via the partition table, this procedure provides a mechanism to control what a user sees on the disk when in an alternate OS environment without requiring additional hardware or physically altering the system architecture.

In the following description, numerous specific details are set forth in order to provide a thorough understanding of the present invention. It will be apparent, however, to one skilled in the art that the present invention may be practiced without some or all of these specific details. In other instances, well known process steps have not been described in detail in order not to unnecessarily obscure the present invention.

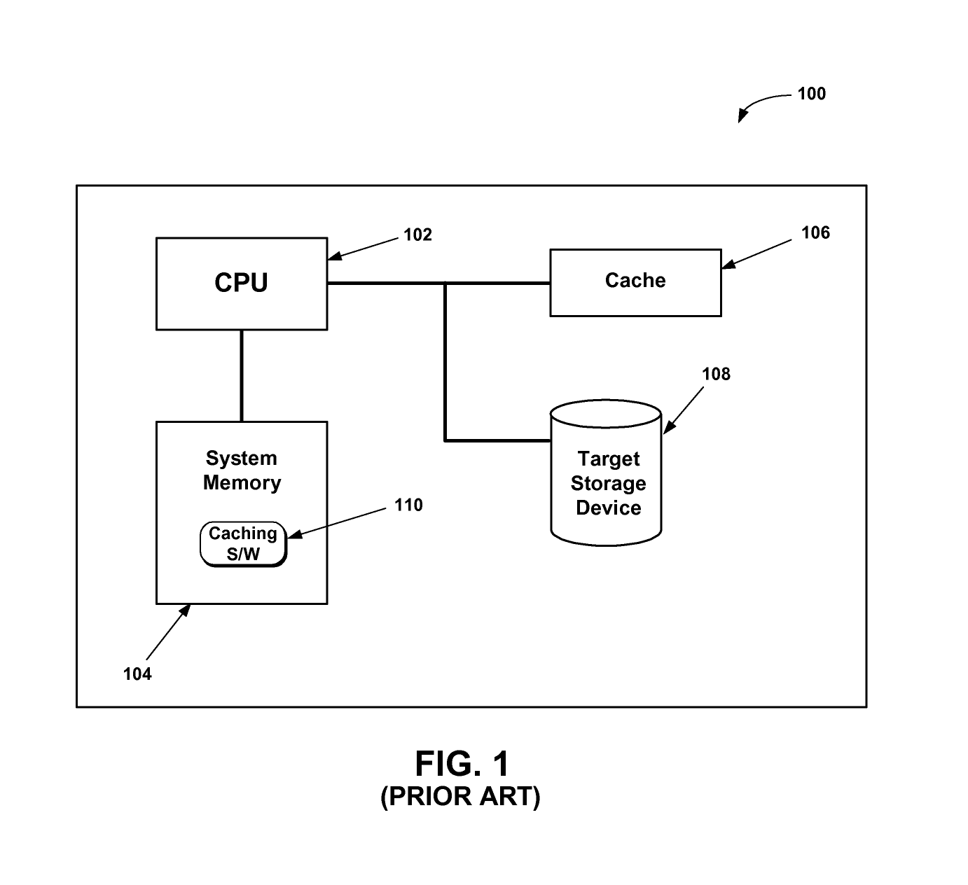

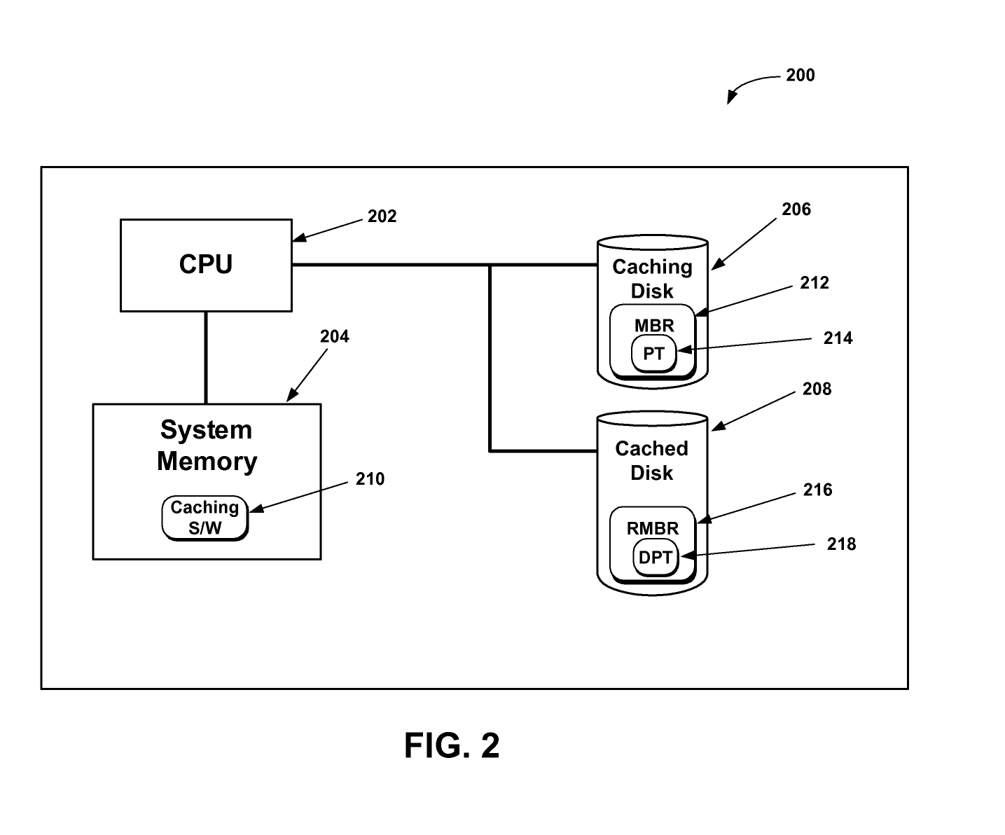

FIG. 1 was described in terms of the prior art. FIG. 2 is a block diagram showing an exemplary computer system 200 with a cached disk 208 having data integrity protection when the cached disk 208 is moved to an alternate OS environment, in accordance with an embodiment of the present invention. The computer system 200 includes a central processing unit (CPU) 202 connected to system memory 204, a caching disk 206, and a cached disk 208. In addition, caching software 210 is loaded into system memory 204 and functions to facilitate write-back caching functionality on the computer system 200.

The caching disk 206 generally is a smaller and faster access disk than that used for the cached disk 208. For example, the caching disk 206 can be a solid state drive (SSD) such as NAND flash based SSD or phase change memory (PCM). Because of the enhance speed of the caching disk 206, reads and writes directed to the caching disk 206 are processed much faster than is possible using the cached disk 208. Write-back caching takes advantage of these differences by sending all write requests to the caching disk 206 before later transferring the data to the cached disk 208. The caching software 210 provides a complete view of the cached disk 208, so the user always sees a complete view of the cached disk 208, regardless of whether or not some data is actually stored on the caching disk 206.

During normal operation, when the CPU 202 processes a write request to write data to the cached disk 208, the caching software 210 intercepts the write request and writes the data to the caching disk 206. This data often is referred to as “dirty” data because it has not yet been written to the cached disk 208, and later becomes “clean” data when it is later written to the cached disk 208. When the CPU 202 processes a read request for the same data, the caching software 210 again intercepts the read request and determines whether the data is located in cache memory. When the data is stored in cache memory, the CPU 202 reads the data from the caching disk 206, otherwise the CPU 202 reads the data from the cached disk 208.

As mentioned above, if the user decides to move a cached disk 208 to another OS environment without the same caching software 210, the data on the cached disk may get corrupted and become useless. Embodiments of the present invention address this issue by replacing the actual partition table of the cached disk 208 with a dummy partition table (DPT) 218, which renders the contents of the cached disk 208 inaccessible when moved to an alternate OS environment.

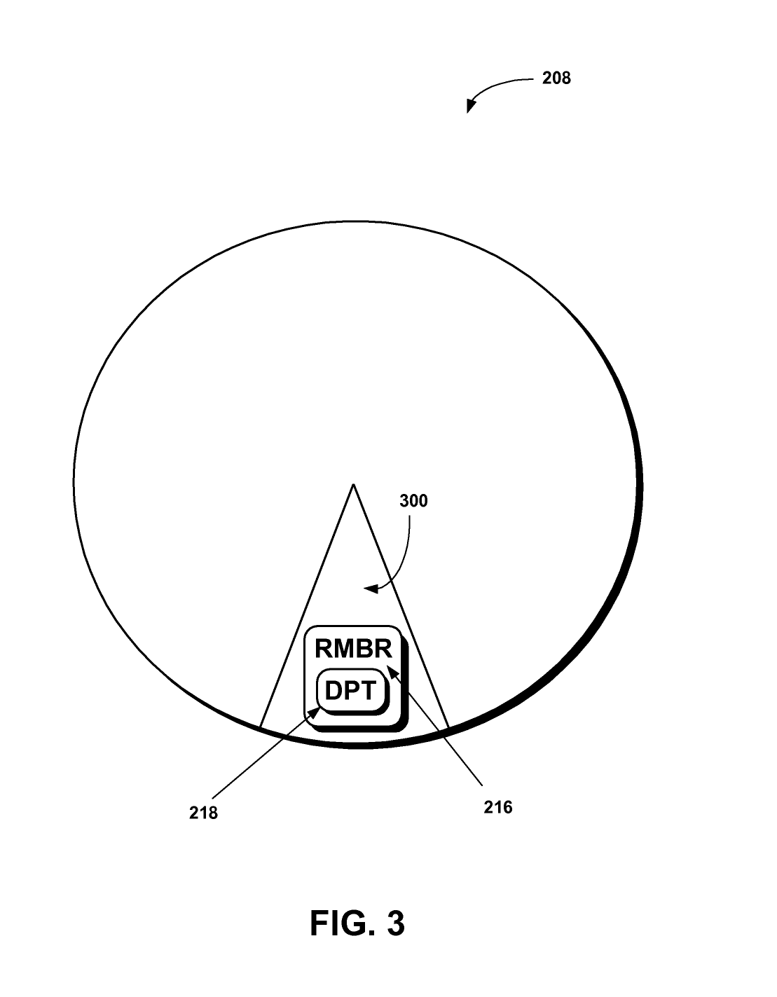

In general, the first code executed by the CPU 202 during system startup is the system BIOS, which sets up the hardware for the computer system 200 and loads the operating system. The system BIOS then identifies a designated boot device, such as the cached disk 208 and attempts to load the operating system (OS) software that further controls the computer system 200. In prior art computer systems, the system BIOS loaded the master boot record (MBR) from the boot sector of the designated boot device to facilitate loading the operating system. The MBR generally was stored in sector 0 of the designated boot device and includes the actual partition table for the disk. The actual partition table for the disk includes layout and partition information to access the data stored on the disk. However, as mentioned above, embodiments of the present invention replace the original partition table for the disk with a dummy partition table. For example, in one embodiment, the original MBR for the cached disk 208 is replaced with a replacement master boot record (RMBR) 216 having a dummy partition table 218, as discussed in greater detail next with reference to FIG. 3.

FIG. 3 is a diagram showing the exemplary cached disk 208, having a replacement master boot record (RMBR) 216 for protecting the cached disk 208 in alternate OS environments, in accordance with an embodiment of the present invention. The cached disk 208 includes a RMBR 216 located in the boot sector 300 of the cached disk 208. The RMBR 216 includes a dummy partition table 218. As described above, the dummy partition table 218 renders the contents of the cached disk 208 inaccessible when the dummy partition table 218 is used to access the cached disk 208. For example, if the actual partition table 214 has multiple Windows New Technology File System (NTFS) entries, the dummy partition table 218 can have a much smaller single File Allocation Table (FAT) entry. Thus, for example, when the cached disk 208, the alternate OS will attempt to use the dummy partition table 218 to access the cached disk 208. As a result, the dummy partition table 218 will render the contents of the cached disk 208 in accessible to the alternate OS.

In this manner, if the cached disk 208 is moved to an alternate OS environment without first disabling the caching software 210, the new computer system will not be able to access any of the data on the cached disk 208 because it will load the RMBR 216 with the dummy partition table 218, which stores incorrect layout and partition information and thus renders the cached disk 208 inaccessible without the proper caching software 210.

As mentioned above, during startup the system BIOS loads code from the boot sector 300 (e.g., sector 0). However, one embodiment of the present invention replaces the MBR normally stored at the boot sector 300 with the RMBR 216 to protect the cached disk 208 in alternate OS environments. Thus, during startup in the embodiment of FIG. 3, the system BIOS loads the RMBR 300 from the boot sector 300 (e.g., sector 0) into system memory, which can include code to load the caching software 210, when the cached disk 208 is utilized as a boot disk for the system.

Referring back to FIG. 2, the actual MBR 212 for the cached disk 208 is stored on the caching disk 206. However, it should be noted that the MBR 212 can be stored in any location other than at the start of the boot sector 300 for the cached disk 208. For example, the MBR 212 can be stored at another non-boot sector of the cached disk 208, with a pointer to the address of the MBR 212 stored on the caching disk 206. The MBR 212 includes the actual partition table 214 for the cached disk 208. The actual partition table 214 includes all the proper partitions and proper volumes for the cached disk. In general, the caching software 210 can keep the partition table 214 current during normal operation.

In this manner, the dummy partition table 218 renders the contents of the cached disk 208 inaccessible when the cached disk 208 is moved to an alternate OS environment not having the same caching software used in the original OS environment. As a result, the user is reminded to return the cached disk 208 back to the original computer system and disable the caching software 210 in order to make the cached disk 208 accessible in the alternate OS environment. To restore the cached disk 208, embodiments of the present invention flush the caching disk 206 and replace the dummy partition table 218 on the cached disk 208 with the actual partition table 214.

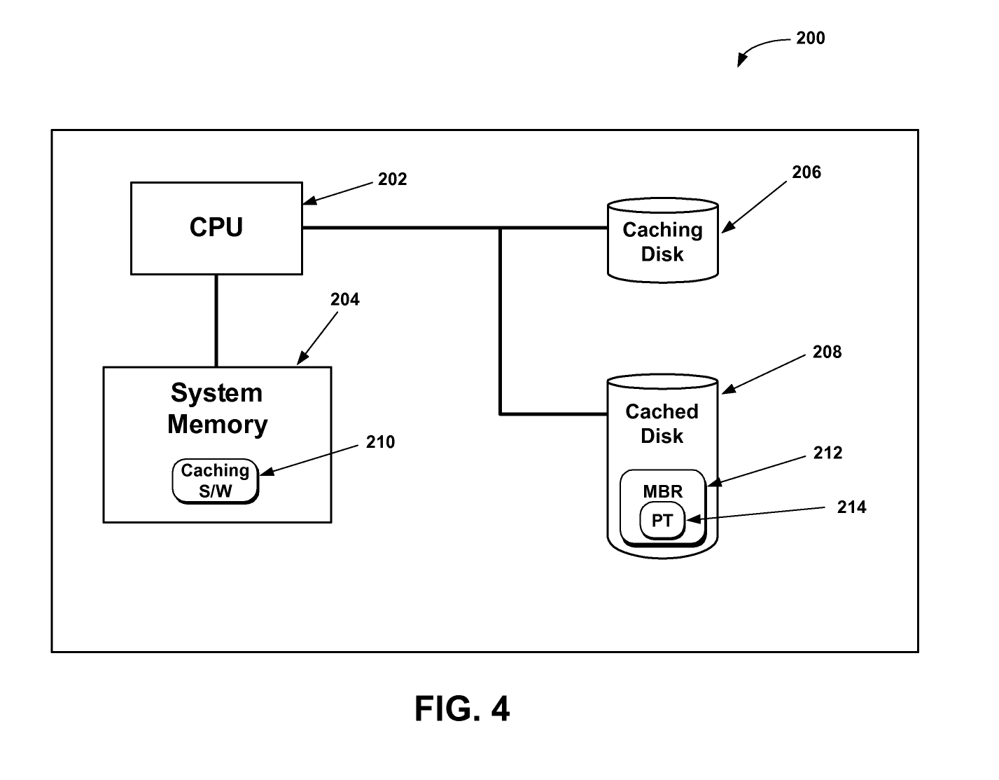

FIG. 4 is a block diagram showing an exemplary computer system 200 wherein the cached disk 208 has been fully updated and made complete in itself and can be safely accessed from an alternate OS where the caching software is not present, in accordance with an embodiment of the present invention. The computer system 200 includes a CPU 202 connected to system memory 204, a caching disk 206, and a cached disk 208. In addition, caching software 210 is loaded into system memory 204 and functions to facilitate write-back caching functionality on the computer system 200. As mentioned above, the caching software 210 provides a complete view of the cached disk 208 to the OS, so the user always sees a complete view of the cached disk 208, regardless of whether or not some data is actually stored on the caching disk 206.

As discussed above, if the user decides to move a cached disk 208 to an alternate OS environment where the same caching software 210 is not present, the dummy partition table renders the contents of the cached disk 208 inaccessible when the dummy partition table is used by the alternate OS environment to access the data on the cached disk 208.

Thus, to move the cached disk 208 to an alternate OS environment, the user should disable disk caching for the cached disk 208 by sending a command to disable caching to the caching software 210. In response to receiving a request to disable caching for the cached disk 208, the caching software 210 prepares the cached disk 208 for safe removal and use in the alternate OS environment.

In particular, the caching software 210 flushes the cached data for the cached disk 208 by ensuring that all the dirty data for the cached disk 208 still on the caching disk 206 is written to the cached disk 208. In addition, the caching software 210 ensures the actual partition table 214 for the cached disk 208 is consistent and complete for the cached disk 208 by performing any updates to the partition table 214 as necessary. Then the caching software 210 writes the actual partition table 214 to the cached disk 208. In the example of FIG. 4, this is done by replacing the RMBR stored on the cached disk 208 with the actual MBR 212 for the cached disk 208, which includes the actual partition table 214. Thereafter, the data on the cached disk 208 is complete. That is, the cached disk 208 is complete in itself and can be accessed safely from an alternate OS where the caching software 210 is not present.

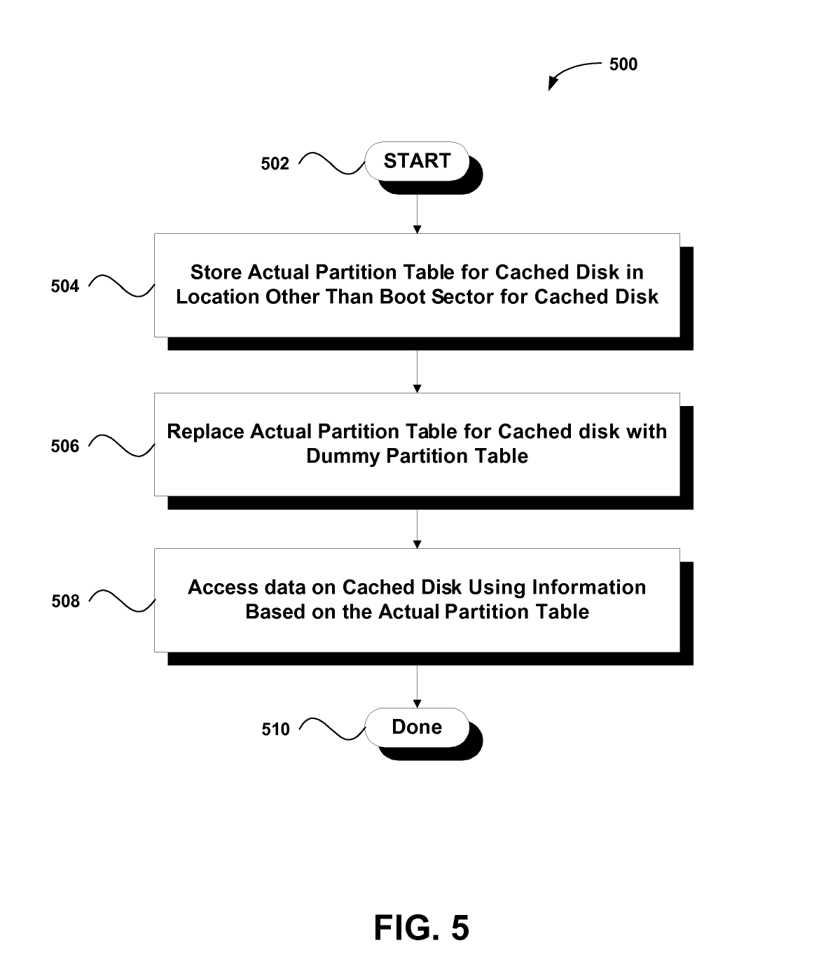

FIG. 5 is a flowchart showing a method 500 for protecting the data integrity of a cached disk when the disk is moved to an alternate OS environment, in accordance with an embodiment of the present invention. In an initial operation 502, preprocess operations are performed. Preprocess operations can include, for example, loading the system BIOS, loading caching software into system memory, and other preprocess operations that will be apparent to those skilled in the art with the hindsight acquired from a careful reading of the present disclosure.

In operation 504, the actual partition table for the cached disk is stored in a location other than the boot sector for the cached disk. Turing to FIG. 2, when the caching software 210 is first installed, and anytime the caching software 210 is newly enabled for a disk to be cached, the partition table for the cached disk 208 is read and stored in a location other than the boot sector of the cached disk 208. Generally, the boot sector for a cached disk is sector zero of that disk, which stores the MBR for the disk. Since the MBR includes the actual partition table for the disk, one embodiment of the present invention reads the MBR for the cached disk and stores the MBR in a location other than the beginning of the boot sector of the cached disk. For example, in FIG. 2 the actual MBR 212 for the cached disk 208, which includes the actual partition table 214, is stored on the caching disk 206.

Referring back to FIG. 5, the actual partition table for the cached disk is replaced with a dummy partition table, in operation 506. As mentioned above, the dummy partition table renders data on the disk inaccessible when the dummy partition table is used by an OS to access the data. Turning to FIG. 2, embodiments of the present invention replace the copy of the MBR 212 on the cached disk with a RMBR 216 having a dummy partition table 218. As noted above, the RMBR 216 is stored in the boot sector, usually sector zero, of the cached disk 208. As such, when the cached disk is accessed via an alternate OS environment without the same caching software 210, the OS will attempt to access the cached disk using the dummy partition table 218. As a result, the data stored on the cached disk 208 will be inaccessible to the alternate OS.

In operation 508 of method 500, the data on the cached disk is accessed using information based on the actual partition table. That is, during normal operation, the caching software 210 intercepts all request to access data on the cached disk 208 in order to perform write-back caching using the caching disk 206. This is accomplished using information based on the actual partition table, which can be updated as data is updated on the caching disk 206 and the cached disk 208.

Post process operations are performed in operation 510. Post process operations can include, for example, handling read and write request, committing dirty data to the cached disk when time permits, and further post process operations that will be apparent to those skilled in the art with the hindsight afforded after a careful reading of the present disclosure.

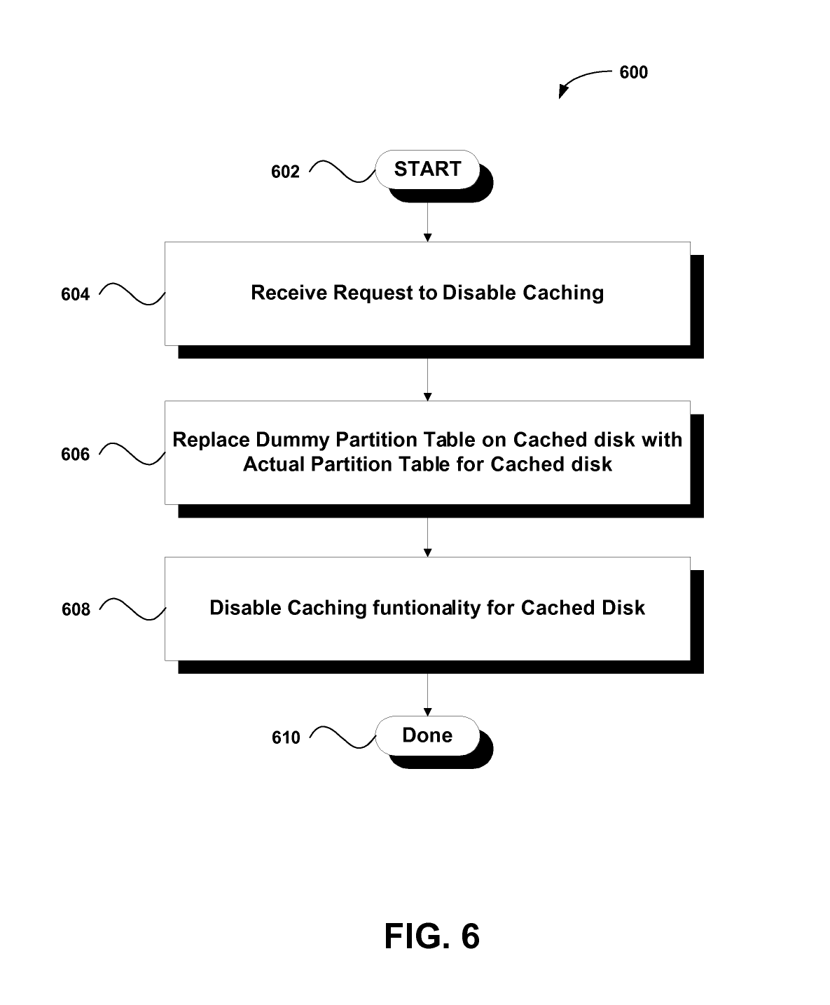

FIG. 6 is flowchart showing a method 600 for rendering the data stored on the cached disk accessible in alternate OS environments in response to receiving a request to disable caching, in accordance with an embodiment of the present invention. In an initial operation 602, preprocess operations are performed. Preprocess operations can include, for example, loading system BIOS into system memory, providing write-back caching functionality for the cached disk, and other preprocess operations that will be apparent to those skilled in the art with the hindsight afforded after a careful reading of the present disclosure.

In operation 604, a request to disable caching is received. When a user wishes to move the cached disk to an alternate OS environment, the user should first disable caching for the cached disk in order to ensure the data stored on the cached disk is fully updated and clean. As will be described in greater detail below, disabling caching for the cached disk triggers the caching software to ensure the disk is fully updated and complete and able to be safely accessed from an alternate OS where the caching software is not present.

In response to receiving the request to disable caching, the dummy partition table on the cached disk is replaced with the actual partition table for the cached disk. This can be performed by replacing the RMBR on the cached disk with a fully updated MBR for the cached disk. Turing to FIG. 4, in response to receiving a request to disable caching for the cached disk 208, the caching software 210 prepares the cached disk 208 for safe removal and use in the alternate OS environment. Hence, the caching software 210 flushes the cached data for the cached disk 208 by ensuring that all the dirty data for the cached disk 208 still on the caching disk 206 is written to the cached disk 208. In addition, the caching software 210 ensures the actual partition table 214 for the cached disk 208 is consistent and complete for the cached disk 208 by performing any updates to the partition table 214 as necessary. Then the caching software 210 writes the actual partition table 214 to the cached disk 208. In the example of FIG. 4, this is done by replacing the RMBR stored on the cached disk 208 with the actual MBR 212 for the cached disk 208, which includes the actual partition table 214. Thereafter, the data on the cached disk 280 is complete. That is, the cached disk 208 is complete in itself and can be accessed safely from an alternate OS where the caching software 210 is not present.

Referring back to FIG. 6, the caching functionality of the cached disk is disabled in operation 608. Once the caching software prepares the cached disk for safe removal and use in the alternate OS environment, caching functionality for the cached disked is disabled and the formally cached disk can be removed to an alternate OS environment and safely accessed. Post process operations are performed in operation 610. Post process operations can include, for example, enabling caching for other devices, removing the formally cached disk from the system, and other post process operations that will be apparent to those skilled in the art with the hindsight afforded after a careful reading of the present disclosure.

Embodiments of the present invention can be utilized in any storage environment where more than one disk is involved to provide the complete view of the storage sub-system. For example, embodiments of the present invention can be utilized in a RAID environment where multiple drives are used to store data. In RAID, the RAID software can be used to provide a complete view of the logical device the RAID represents. However, the individual disks of the RAID array can each have their partition table replaced with a dummy partition table that renders the data stored on the disk inaccessible when the disk is moved to an alternate OS environment where the RAID software is not present. In this manner, the integrity of the data on the individual RAID disks can be protected should any disk be mistakenly moved to an alternate OS environment.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

What is claimed is:

1. A method for protecting data integrity of a disk in an alternate operating system (OS) environment, comprising:
replacing an actual partition table for a disk with a dummy partition table, wherein the dummy partition table renders data on the disk inaccessible when the dummy partition table is used by an OS to access the data; and
accessing the data on the disk using information based on the actual partition table.

2. A method as recited in claim 1, further comprising the operation of replacing an actual master boot record for the disk with a replacement master boot record, wherein the replacement master boot record includes the dummy partition table.

3. A method as recited in claim 2, wherein the replacement master boot record is stored in a boot sector of the disk.

4. A method as recited in claim 1, further comprising replacing the dummy partition table on the disk with the actual partition table in response to receiving a request to disable caching.

5. A method as recited in claim 4, further comprising the operation of replacing a replacement master boot record on the disk with an actual master boot record for the disk, wherein the replacement master boot record includes the dummy partition table, and wherein the actual master boot record includes the actual partition table for the disk.

6. A method as recited in claim 1, wherein the actual partition table is stored on a caching disk, wherein the caching disk is utilized for write-back caching to store cached data for the disk.

7. A method as recited in claim 1, wherein the actual partition table is stored on the disk in a non-boot sector.

8. A method for protecting data integrity of a disk in an alternate operating system (OS) environment, comprising:
replacing an actual partition table for a disk with a dummy partition table, wherein the dummy partition table renders data on the disk inaccessible when the dummy partition table is used by an OS to access the data;
accessing the data on the disk using information based on the actual partition table; and
replacing the dummy partition table on the disk with the actual partition table in response to receiving a request to disable caching.

9. A method as recited in claim 8, further comprising the operation of replacing an actual master boot record for the disk with a replacement master boot record, wherein the replacement master boot record includes the dummy partition table.

10. A method as recited in claim 9, wherein the replacement master boot record is stored in a boot sector of the disk.

11. A method as recited in claim 9, further comprising the operation of replacing a replacement master boot record on the disk with an actual master boot record for the disk, wherein the replacement master boot record includes the dummy partition table, and wherein the actual master boot record includes the actual partition table for the disk.

12. A method as recited in claim 8, wherein the actual partition table is stored on a caching disk, wherein the caching disk is utilized for write-back caching to store cached data for the disk.

13. A method as recited in claim 8, wherein the actual partition table is stored on the disk in a non-boot sector.

14. A computer program embodied on a computer readable medium for protecting data integrity of a disk in an alternate operating system (OS) environment, comprising:
computer instructions that replace an actual partition table for a disk with a dummy partition table, wherein the dummy partition table renders data on the disk inaccessible when the dummy partition table is used by an OS to access the data; and
computer instructions that access the data on the disk using information based on the actual partition table.

15. A computer program as recited in claim 14, further comprising computer instructions that replace an actual master boot record for the disk with a replacement master boot record, wherein the replacement master boot record includes the dummy partition table.

16. A computer program as recited in claim 15, wherein the replacement master boot record is stored in a boot sector of the disk.

17. A computer program as recited in claim 14, further comprising computer instructions that replace the dummy partition table on the disk with the actual partition table in response to receiving a request to disable caching.

18. A computer program as recited in claim 17, further comprising computer instructions that replace a replacement master boot record on the disk with an actual master boot record for the disk, wherein the replacement master boot record includes the dummy partition table, and wherein the actual master boot record includes the actual partition table for the disk.

19. A computer program as recited in claim 14, wherein the actual partition table is stored on a caching disk, wherein the caching disk is utilized for write-back caching to store cached data for the disk.

20. A computer program as recited in claim 14, wherein the actual partition table is stored on the disk in a non-boot sector.
